(19) United States
(12) Patent Application Publication
(10) Pub. No.: US 2012/0044112 A1
(43) Pub. Date: Feb. 23, 2012

(54) LOCAL AREA NETWORK ANTENNA FOR A MOBILE COMPUTING DEVICE

(75) Inventor: David E. Bellows, Wantagh, NY (US)

(73) Assignee: Symbol Technologies, Inc., Schaumburg, IL (US)

(21) Appl. No.: 12/858,561

(22) Filed: Aug. 18, 2010

(51) Int. Cl. H01Q 1/24

(52) U.S. Cl. 343/702

(57) ABSTRACT

An antenna for a mobile device is described. The antenna includes a housing formed from a metal material. The housing functions as a ground plane for the antenna and an RF shield for at least one electronic component of the mobile device. An insulating material covers at least a portion of the housing. The antenna also includes a radiating element disposed on the insulating material.

### TECHNICAL FIELD

The invention relates generally to an integrated and isolated local area network (LAN) antenna for a mobile computing device.

### BACKGROUND

Mobile computing devices generally include transceivers, such as local area network transceivers for communicating with a local area network (LAN). The transceiver is connected to a LAN antenna included inside the housing of the mobile device. Typical LAN antennas require a significant air gap between the electronic circuitry and the radiating element of the antenna. This air gap requirement limits design flexibility relating to the minimum dimensions with which the housing can be made.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a front view of a mobile computing device according to one embodiment of the invention.

FIG. 2 is a block diagram illustrating the electronic components of the mobile computing device of FIG. 1.

FIG. 3 illustrates a cross-sectional view of a LAN antenna according to one embodiment of the invention.

FIG. 4A and FIG. 4B illustrate cross-sectional views of LAN antennas according to other embodiments of the invention

FIG. 5A and FIG. 5B illustrate perspective views of mobile devices including LAN antennas according to the invention.

FIG. 6 is a graphical illustration of properties of an antenna of the present invention.

### SUMMARY

In one aspect, the invention is embodied in an antenna for a mobile device. The antenna includes a housing formed from a metal material. The housing functions as a ground plane for the antenna and an RF shield for at least one electronic component of the mobile device. The antenna also includes an insulating material covering at least a portion of the housing and a radiating element disposed on the insulating material.

In one embodiment, the insulating material includes a dielectric material. The insulating material can also include a plastic material, a rubber material, an elastomer material, or a polymeric material.

One or more electrical components of the mobile device are grounded to the ground plane. The radiating element can be coupled to the radio of the mobile device. The antenna can also include a coaxial cable having a center conductor coupled to the radiating element and an outer shield coupled to the ground plane.

The radiating element can be oriented substantially parallel to the ground plane. In one embodiment, the antenna is an inverted-F antenna. In yet another embodiment, the antenna can be a patch antenna.

In another aspect, the invention is embodied in a method of forming an antenna for a mobile device. The method includes forming a housing of the mobile device from a metal material to function as a ground plane of the antenna and an RF shield for at least one electronic component of the mobile device. The insulating material can include a dielectric material.

The method can also include grounding one or more electrical components of the mobile device to the ground plane. In one embodiment, the radiating element is coupled to a radio of the mobile device. In one embodiment, a center conductor of a coaxial cable is coupled to the radiating element and an outer shield of a coaxial cable is coupled to the ground plane. The method can also include orienting the radiating element substantially parallel to the ground plane.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional local area network (LAN) antennas, need not, and are not, described in detail herein.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to systems utilizing LAN antennas. In an exemplary embodiment, a LAN antenna is integrated into a housing of a mobile device. The housing functions as a ground plane for the antenna, as well as a radio-frequency (RF) shield for the electronic components of the mobile device. The invention is described with reference to a single band planar inverted-F antenna (PIFA). However, skilled artisans will appreciate that the techniques described herein can be extended to multi-band, including tri- and quad-band designs.

Because the housing functions as a ground plane for the antenna and an RF shield for at least one component of the mobile device, the properties of the antenna of the present invention are not affected by the internal electronic components of the mobile device. In contrast, in a typical antenna, a suitable air gap would be required between the internal electronics and the antenna to attempt to minimize the effects of these internal electronic components on the antenna performance. This air gap can affect the dimensions of the enclosure, thereby constraining the designer of the mobile device. No such air gap is required for the present invention. Additionally, the design of the antenna of the present invention can remain fixed even as internal components of the mobile device are modified or re-configured. For example, only a single antenna design is required to support a multitude of internal electronic configurations.

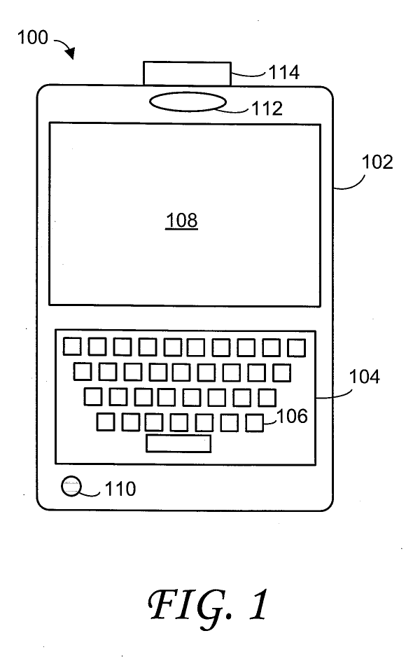

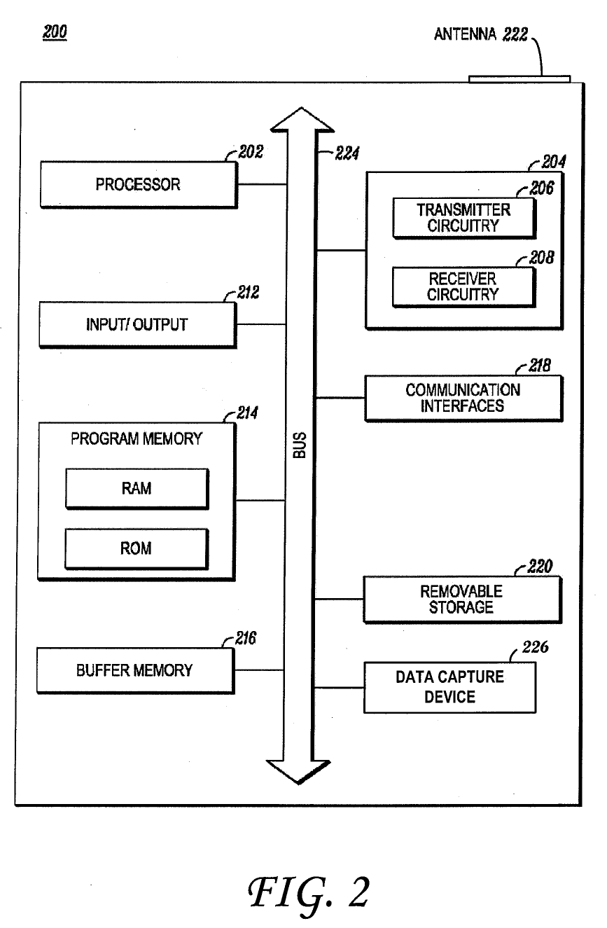

FIG. 1 is a front view of a mobile computing device 100 according to one embodiment of the invention. The mobile computing device 100 includes a housing 102. The housing 102 contains electronic components, including internal communication components and circuitry as further described with relation to FIG. 2 to enable the device 100 to communicate wirelessly with other devices. The housing 102 also contains I/O devices such as a keyboard 104 with alpha-numeric keys 106, a display 108 (e.g., LED, OLED) that displays information about the device 100, soft and/or hard keys, touch screen, jog wheel, a microphone 110, and a speaker 112. The mobile computing device 100 can also include a data capture device 114, such as a laser scanner, imager, or radio-frequency identification (RFID) reader. In some embodiments, the device 100 includes less than all of the I/O devices shown in FIG. 1.

FIG. 2 is a block diagram 200 illustrating the electronic components of the mobile computing device 100 (FIG. 1) according to the invention. The mobile computing device 100 contains, among other components, a processor 202, a transceiver 204 including transmitter circuitry 206 and receiver circuitry 208, an antenna 222, the I/O devices 212 described in relation to FIG. 1, a program memory 214 for storing operating instructions that are executed by the processor 202, a buffer memory 216, one or more communication interfaces 218, a data capture device 226, such as a laser scanner, imager, or radio-frequency identification (RFID) reader, and an optional removable storage 220. The mobile computing device 100 is preferably an integrated unit containing the elements depicted in FIG. 2, as well as any other element necessary for the mobile computing device 100 to function. In one embodiment, the electronic components are connected by a bus 224.

The processor 202 can include one or more microprocessors, microcontrollers, DSPs, state machines, logic circuitry, or any other device or devices that process information based on operational or programming instructions. Such operational or programming instructions are preferably stored in the program memory 214. The program memory 214 can be an IC memory chip containing any form of random access memory (RAM) or read only memory (ROM), a floppy disk, a compact disk (CD) ROM, a hard disk drive, a digital video disk (DVD), a flash memory card or any other medium for storing digital information. Skilled artisans will recognize that when the processor 202 has one or more of its functions performed by a state machine or logic circuitry, the program memory 214 containing the corresponding operational instructions may be embedded within the state machine or logic circuitry. Operations performed by the processor 202 as well as the mobile computing device 100 are described in detail below.

The transmitter circuitry 206 and the receiver circuitry 208 enable the mobile computing device 100 to respectively transmit and receive communication signals. In this regard, the transmitter circuitry 206 and the receiver circuitry 208 include circuitry to enable wireless transmissions. The implementations of the transmitter circuitry 206 and the receiver circuitry 208 depend on the implementation of the mobile computing device 100 and the devices with which it is to communicate. For example, the transmitter and receiver circuitry 206, 208 can be implemented as part of the communication device hardware and software architecture in accordance with known techniques. One of ordinary skill in the art will recognize that most, if not all, of the functions of the transmitter or receiver circuitry 206, 208 can be implemented in a processor, such as the processor 202. However, the processor 202, the transmitter circuitry 206, and the receiver circuitry 208 have been partitioned herein to facilitate a better understanding of the functions of these elements. In one embodiment, the antenna 222 is a local area network (LAN) antenna coupled to the transceiver 204.

The buffer memory 216 may be any form of volatile memory, such as RAM, and is used for temporarily storing received information. The removable memory 220 can be a secure digital (SD) memory card, for example.

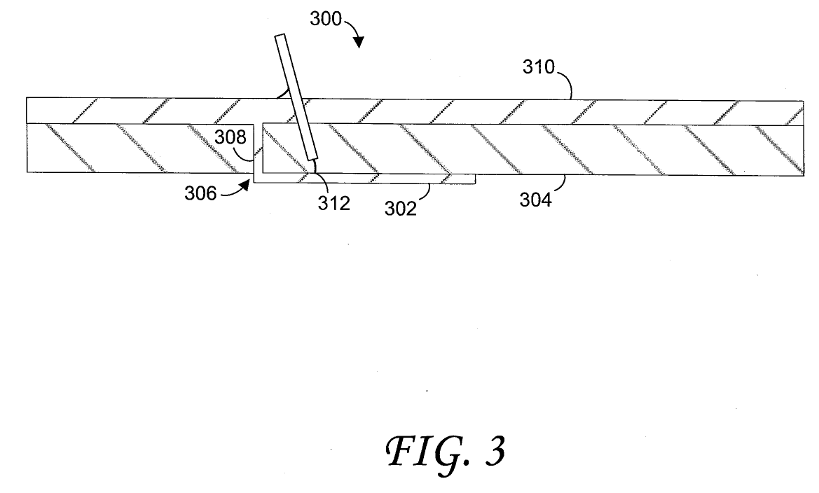

FIG. 3 illustrates a PIFA antenna 300 for a mobile device according to one embodiment of the invention. The PIFA antenna 300 is generally arranged to include a single element radiator 302 formed adjacent to an insulating material 304. By radiator, we mean the radiating element of the antenna 300. The insulating material 304 can be a dielectric material. In one embodiment, the insulating material 304 is over-molded on a housing of the mobile device.

The single element radiator 302 can be substantially rectangular or any suitable shape. The radiator 302 can be solid or can include slots or other voids.

Voids can be formed in the radiator 302 to create resonances in the modal distribution at different frequencies of the antenna. An opening 306 in the insulating material 304 accommodates a shorting post 308. In one embodiment, the shorting post 308 is integrated with the radiator 302.

In one embodiment, the antenna 300 will generally resonate in a single band. For example, the antenna 300 can resonate in the frequency range of about 2.4 GHz to 2.5 GHz. However, skilled artisans will appreciate that various modifications to the radiator 302 can increase the number of resonance bands of the antenna 300.

A ground plane 310 is generally formed from an electrically conductive material and is electrically opposed to the radiator 302. For example, the ground plane 310 can be fabricated from a metal material. In one embodiment, the radiator 302 and the ground plane 310 are substantially parallel to each other.

The shorting post 308 shorts an end of the single element radiator 302 to the ground plane 310. In one embodiment, the shorting post 308 is integrated with the ground plane 310. Alternatively, the shorting post 308 is electrically connected to the radiator 302 and the ground plane 310.

In one embodiment, the ground plane 310 functions as a radio-frequency RF shield for at least some of the electronic components of the mobile device (not shown). In this embodiment, the ground plane 310 substantially surrounds the electronic components. For example, the ground plane 310 can form the housing of the mobile device.

The resonant frequency of the antenna 300 is set by factors including the distance between the ground plane 310 and the radiator 302, the material properties of the insulating material 304, the length and width of the radiator 302, and the relationship of these dimensions to a feed point 312. For example, reducing the length of the radiator 302 tends to increase the frequency of the antenna's resonance, and increasing the length of the radiator 302 tends to decrease the frequency of the antenna's resonance.

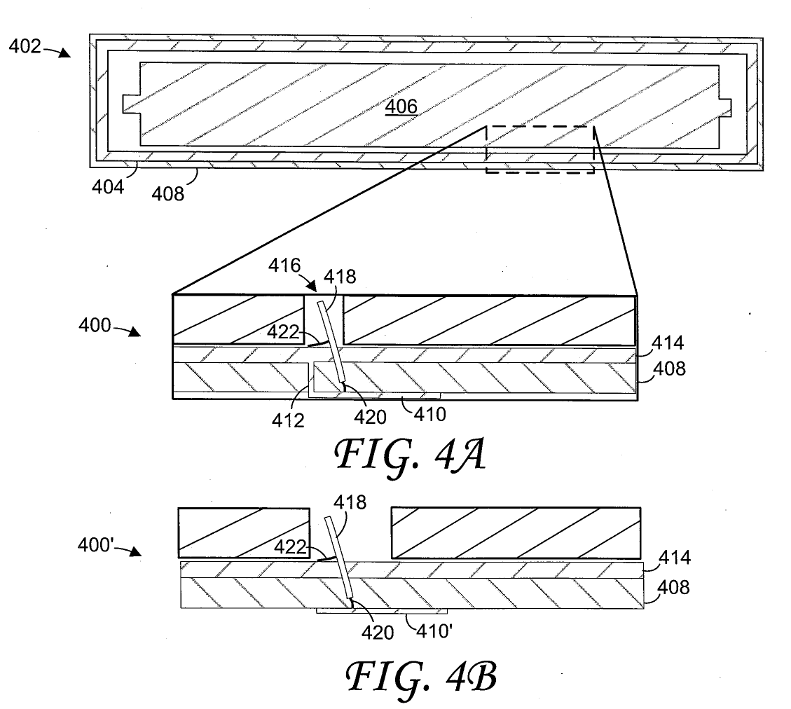

FIGS. 4A and 4B illustrate two possible implementations of an antenna 400, 400′ integrated with a housing 402 of a mobile device according to the invention. The housing 402 can include an enclosure 404 formed from a metal material. The enclosure 404 substantially surrounds at least some of the electronic components 406 of the mobile device that are susceptible to radio-frequency (RF) interference from the antenna 400, 400′or the external environment. Note that the size of the air gap between the electronic components 406 and the enclosure 404 is not critical. In fact, in one embodiment of the present invention, the distance between the electronic components 406 and the enclosure 404 can be substantially zero.

The enclosure 404 need not be completely sealed in order to provide adequate RF shielding. For example, the enclosure 404 may include one or more openings to accommodate a display, a keypad, other I/O components, a battery, or access to a removable memory.

An insulating material 408 can cover at least a portion of the enclosure 404. For example, the insulating material 408 can be overmolded on the enclosure 404. In one embodiment, the insulating material 408 is a dielectric material. Other suitable materials could also be used. The insulating material 408 forms the external “skin” over the housing 402. For example, when a user holds the mobile device in a hand, the user's hand will contact the insulating material 408.

FIG. 4A illustrates a planar inverted-F (PIFA) antenna 400 according to one embodiment of the invention. A radiating element 410 can be formed from a single sheet of conductive material that is pressed into a suitable shape. The radiating element 410 is positioned on the insulating material 408. Skilled artisans will appreciate that the antenna 400 can also be fabricated by a metal deposit, printing or plating over the insulating material 408. In one embodiment, the radiating element 410 can include an integrated shorting post 412. For example, the radiating element 410 and the shorting post 412 can be fabricated from a single piece of material.

The radiating element 410 is generally parallel to the ground plane 414. The ground plane 414 is integrated with the enclosure 404. For example, the ground plane 414 and the enclosure 404 can be embodied in the same physical component. In one embodiment, the shorting post 412 is generally perpendicular to the radiating element 410. The shorting post 412 is connected to the ground plane 414.

The antenna 400 also includes a feed 416. The feed 416 emanates from a transceiver (not shown) of the mobile device. The feed 416 can be a coaxial feed 418 having a center conductor 420 and a shield 422 that surrounds the center conductor 420. The center conductor 420 of the coaxial feed 418 extends through the insulating material 408 and is connected to the radiating element 410. The shield 422 is connected to the ground plane 414.

FIG. 4B illustrates a patch-type antenna 400′ according to one embodiment of the invention. The patch-type antenna 400′ includes a radiating element 410′ as well as the ground plane 414. The patch-type antenna 400′ does not require a shorting post. The center conductor 420 of the coaxial feed 418 extends through the insulating material 408 and is connected to the radiating element 410′. The shield 422 is connected to the ground plane 414.

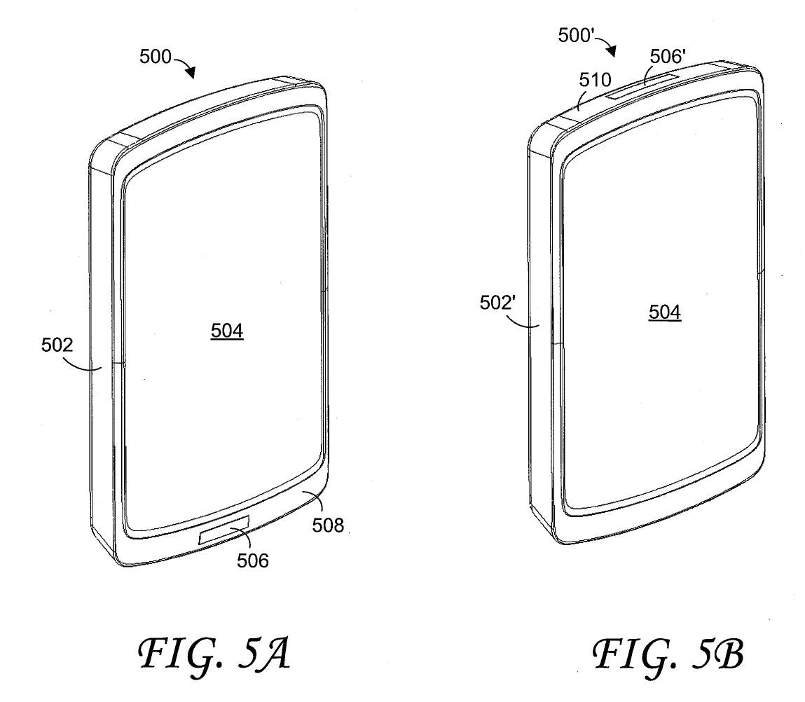

FIGS. 5A and 5B illustrate perspective views of mobile devices 500, 500′ according to the invention. The mobile devices 500, 500′ each include a housing 502, 502′. Each of the mobile devices 500, 500′ includes a display 504. An antenna 506 of FIG. 5A is positioned below the display 504 on the front surface 508 of the housing 502. An antenna 506′ of FIG. 5B is positioned on a top surface 510 of the housing 502′.

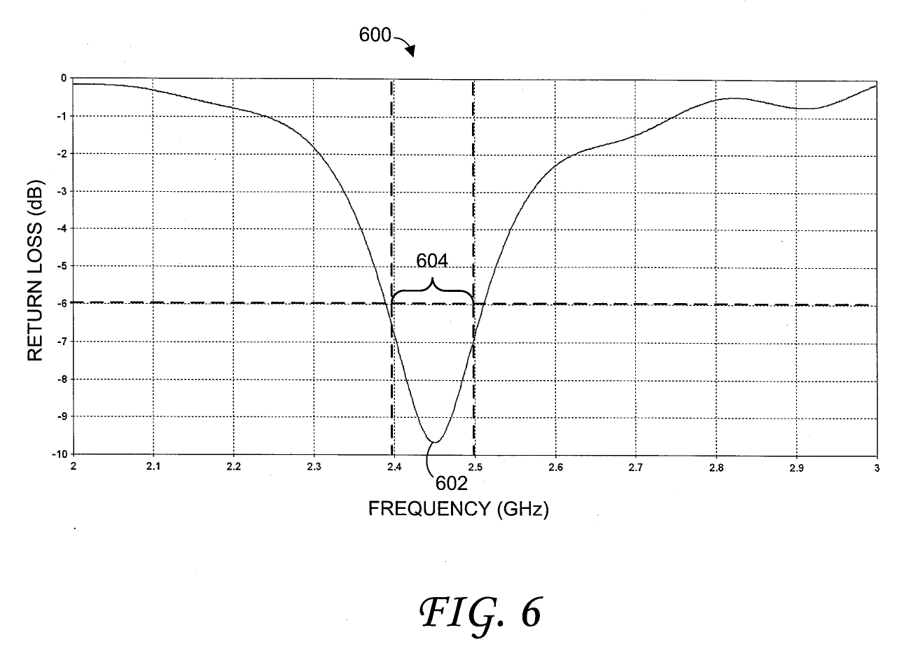

FIG. 6 is a graphical illustration 600 of properties of the antenna of the present invention. Embodiments of antennas of the type shown in FIGS. 5A and 5B have been physically modeled and prototypes have been tested. Modeling indicates that the antenna exhibits a frequency resonance 602. Dimensions for an exemplary prototype embodiment are approximately four inches tall by three inches wide by 1 inch deep.

The antennas 400, 400′ of FIGS. 4A and 4B are intended to be suitable for operation under the IEEE 802.11 wireless specification. According to the testing, the antenna 400 meets typical return loss bandwidth for the frequency band 604 in which it operates, namely between 2.4 GHz and 2.5 GHz.

The antenna is tuned, by the sizing methods described above or by adjusting the size of the radiating element, separation between the radiating element and ground plane(s), and/or feed/short locations. Skilled artisans will appreciate that an antenna according to the invention can include impedance matching circuitry (not shown). In one embodiment, the PIFA arrangement of the invention produces a high efficiency antenna that does not require a matching network because the impedance is large enough to render any impedance mismatch losses small across the entire operating band of the antenna.

In general, the processor 202 (FIG. 2) of the mobile device 200 includes processing logic configured to carry out the functions, techniques, and processing tasks associated with the operation of the mobile device 200. Furthermore, the steps of a method or algorithm described in connection with the embodiments disclosed herein may be embodied directly in hardware, in firmware, in a software module executed by the processor 202, or any combination thereof. Any such software may be implemented as low level instructions (assembly code, machine code, etc.) or as higher-level interpreted or compiled software code (e.g., C, C++, Objective-C, Java, Python, etc.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for the near-field wireless device pairing described herein. The non-processor circuits may include, but are not limited to, a radio receiver, a radio transmitter, signal drivers, clock circuits, power source circuits, and user input devices. As such, these functions may be interpreted as steps of a method to perform the near-field wireless device pairing described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. An antenna for a mobile device comprising:
a housing formed from a metal material, the housing functioning as a ground plane for the antenna and an RF shield for at least one electronic component of the mobile device;
an insulating material covering at least a portion of the housing; and
a radiating element disposed on the insulating material.

2. The antenna of claim 1 wherein the insulating material comprises a dielectric material.

3. The antenna of claim 1 wherein the insulating material comprises at least one of a plastic material, a rubber material, an elastomer material, and a polymeric material.

4. The antenna of claim 1 wherein one or more electrical components of the mobile device are grounded to the ground plane.

5. The antenna of claim 1 wherein the radiating element is coupled to a radio of the mobile device.

6. The antenna of claim 1 further comprising a coaxial cable having a center conductor coupled to the radiating element and an outer shield coupled to the ground plane.

7. The antenna of claim 1 wherein the radiating element is oriented substantially parallel to the ground plane.

8. The antenna of claim 1 wherein the antenna is an inverted-F antenna.

9. The antenna of claim 1 wherein the antenna is a patch antenna.

10. A method of forming an antenna for a mobile device comprising:
forming a housing of the mobile device to function as a ground plane of the antenna and an RF shield for at least one electronic component of the mobile device;
covering at least a portion of the housing with an insulating material; and
disposing a radiating element on the insulating material.

11. The method of claim 10 wherein the insulating material comprises a dielectric material.

12. The method of claim 10 further comprising grounding one or more electrical components of the mobile device to the ground plane.

13. The method of claim 10 further comprising coupling the radiating element to a radio of the mobile device.

14. The method of claim 10 further comprising coupling a center conductor of a coaxial cable to the radiating element and coupling an outer shield of the coaxial cable to the ground plane.

15. The method of claim 10 further comprising orienting the radiating element substantially parallel to the ground plane.

16. An antenna for a mobile device comprising:
means for forming a housing of the mobile device to function as a ground plane of the antenna and an RF shield for at least one electronic component of the mobile device;
means for covering at least a portion of the housing with an insulating material; and
means for disposing a radiating element on the insulating material.

17. The antenna of claim 16 wherein the insulating material comprises a dielectric material.

18. The antenna of claim 16 wherein the radiating element is coupled to a radio of the mobile device.

19. The antenna of claim 16 further comprising a coaxial cable having a center conductor coupled to the radiating element and an outer shield coupled to the ground plane.

20. The antenna of claim 16 wherein the radiating element is oriented substantially parallel to the ground plane.
